(19) United States
(12) Patent Application Publication
(10) Pub. No.: US 2013/0124886 A1
(43) Pub. Date: May 16, 2013

(54) Power Control Device and Electronic Device Using the Same

(71) Applicant: Chih-Chain Kung, New Taipei City (TW)

(72) Inventor: Chih-Chain Kung, New Taipei City (TW)

(21) Appl. No.: 13/345,770

(22) Filed: Jan. 9, 2012

(30) Foreign Application Priority Data
Nov. 16, 2011 (TW) 100141758

(51) Int. Cl. G06F 1/32

(52) U.S. Cl. 713/320

(57) ABSTRACT

The invention discloses a power control device for an electronic device, comprising a power supply unit and a control circuit. The power supply unit outputs a power to an embedded controller of the electronic device according to a power control signal. The control circuit is coupled to the embedded controller, for outputting the power control signal according to an operating status indication signal generated by the embedded controller, so as to control the power supply unit to stop outputting power to the embedded controller via the power control signal when the operating status indication signal signifies a turn-off status.

### BACKGROUND OF THE INVENTION

1. Field of the Invention

The present invention relates to a power control device and electronic device thereof, and more particularly, to a power control device and electronic device thereof capable of turning off the power of an embedded controller of an electronic device when the electronic device operates in a turn-off status, so as to decrease power consumption of the electronic device.

2. Description of the Prior Art

Portable electronic devices, such as laptops, tablets, smart phones, etc., are widely used in daily life. Generally speaking, the operating power of the portable electronic devices is stored in batteries. When the power of batteries has run out, then, the portable electronic devices cannot work. In such a condition, how to lower the power consumption of the portable electronic devices is important.

Conventionally, in order to lower the power consumption of a portable electronic device, user turns off the portable electronic device when the portable electronic devices do not need to work, so as to turn off most of circuits of the portable electronic device and to decrease the power consumption of the portable electronic device. However, in order to ensure the portable electronic device reboots properly, the portable electronic device still needs to offer power to a related controller to detect whether the portable electronic device needs to be rebooted even if the portable electronic device operates in the turn-off status. In other words, the portable electronic device still consumes a certain level of power when the portable electronic device operates in the turn-off status. In such a condition, how to effectively decrease power consumption of the portable electronic device when the portable electronic device operates in the turn-off status becomes a goal in the industry.

### SUMMARY OF THE INVENTION

Therefore, the present invention mainly provides a power control device and electronic device thereof to lower power consumption of the electronic device when the electronic device operates in the turn-off status.

An embodiment of the invention discloses a power control device, for an electronic device, comprising: a power supply unit, for outputting a power to an embedded controller of the electronic device according to a power control signal, and a control circuit, coupled to the power supply unit and the embedded controller for outputting the power control signal according to an operating status indication signal, so as to control the power supply unit to stop outputting the power to the embedded controller when the operating status indication signal signifies a turn-off status.

An embodiment of the invention further discloses an electronic device, including an embedded controller; a power control device, having a power supply unit for outputting a power to the embedded controller according to a power control signal; and a control circuit coupled to the power supply unit and the embedded controller for outputting the power control signal according to an operating status indication signal, so as to control the power supply unit to stop outputting the power to the embedded controller when the operating status indication signal signifies a turn-off status.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the invention.

FIG. 2 is a schematic diagram of another implementation of the electronic device shown in FIG. 1.

FIG. 3 is a waveform chart of related signals during operation of the electronic device shown in FIG. 2.

FIG. 4 is a schematic diagram of another implementation of the electronic device shown in FIG. 1.

### DETAILED DESCRIPTION

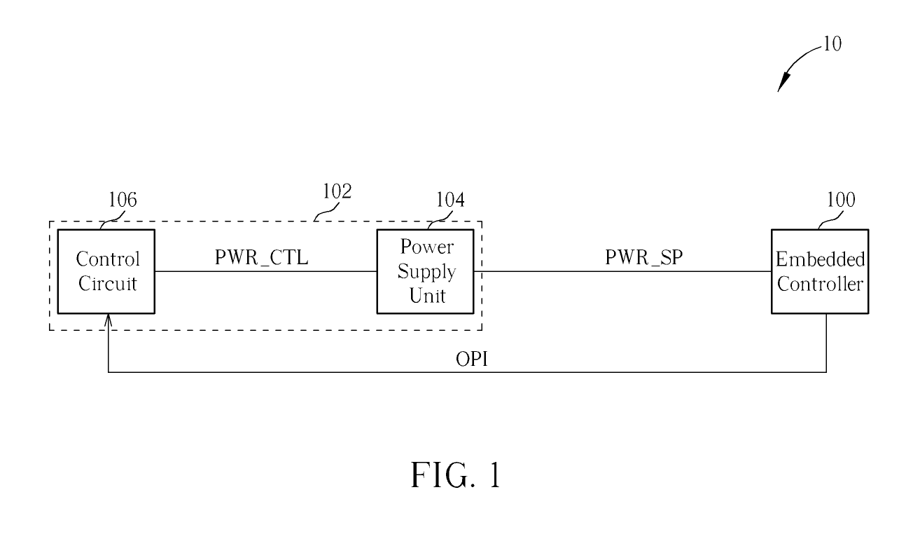

Please refer to FIG. 1, where FIG. 1 is a schematic diagram of an electronic device 10 according to an embodiment of the invention. The electronic device 10 is any device that utilizes electricity as an operating power, and the structure and the composition of the electronic device 10 can be different according to different applications. Therefore, in brief, an embedded controller 100 and a power control device 102 of the electronic device 10 are shown in FIG. 1, the components unrelated to the concept of the present invention, such as housings, operating circuits, connection interfaces, are not shown in FIG. 1. The embedded controller 100 detects an operating status of the electronic device 10, for example detects whether the electronic device 10 is in an operational status or in a turn-off status, so as to output an operating status indication signal OPI to the power control device 102, wherein the operating status indication signal OPI signifies the operating status detected by the embedded controller 100. The embedded controller 100 can be a calculating device, such as a micro processor, a micro controller, etc., but is not limited thereto. The power control device 102 comprises a power supply unit 104 and a control circuit 106. The control circuit 106 outputs a power control signal PWR_CTL to the power supply unit 104 according to the operating status indication signal OPI outputted by the embedded controller 100, so as to control the power supply unit 104 to output a power PWR_SP to the embedded controller 100 or to stop outputting the power PWR_SP to the embedded controller 100. More precisely, when the electronic device 10 operates in a turn-off status, the embedded controller 100 indicates to the control circuit 106 via the operating status indication signal OPI, and the control circuit 106 accordingly controls the power supply unit 104 to stop outputting the power PWR_SP to the embedded controller 100. As a result, the power consumption of the electronic device 10 is decreased when the electronic device 10 operates in a turn-off status.

In the present invention, the power supply unit 104 is an energy storage device (such as a battery, a rechargeable battery, etc.) or a power converter (such as a DC-DC converter, a Linear Drop Out converter, etc.). In addition, the power supply unit 104 is controlled by the control circuit 106 to timely output the power PWR_SP to the embedded controller 100. More precisely, when the user activates the electronic device 10 through pressing a power button of the electronic device 10 or offering an external power source to the electronic device 10, the embedded controller 100 controls the power supply unit 104 to start outputting the power PWR_SP to the embedded controller 102 through outputting the appropriate operating status indication signal OPI. On the other hand, when the electronic device 10 is in a turn-off status, the embedded controller 100 switches the operating status indication signal OPI to indicate to the control circuit 106 to output the corresponding power control signal PWR_CTL, so as to control the power supply device 104 stop outputting the power PWR_SP to the embedded controller 102. In other words, when the electronic device 10 is in a turn-off status, the embedded controller 100 is not powered, i.e. the power supply unit 104 stops outputting the power PWR_SP to the embedded controller 100, so as to decrease the power consumption of the electronic device 10.

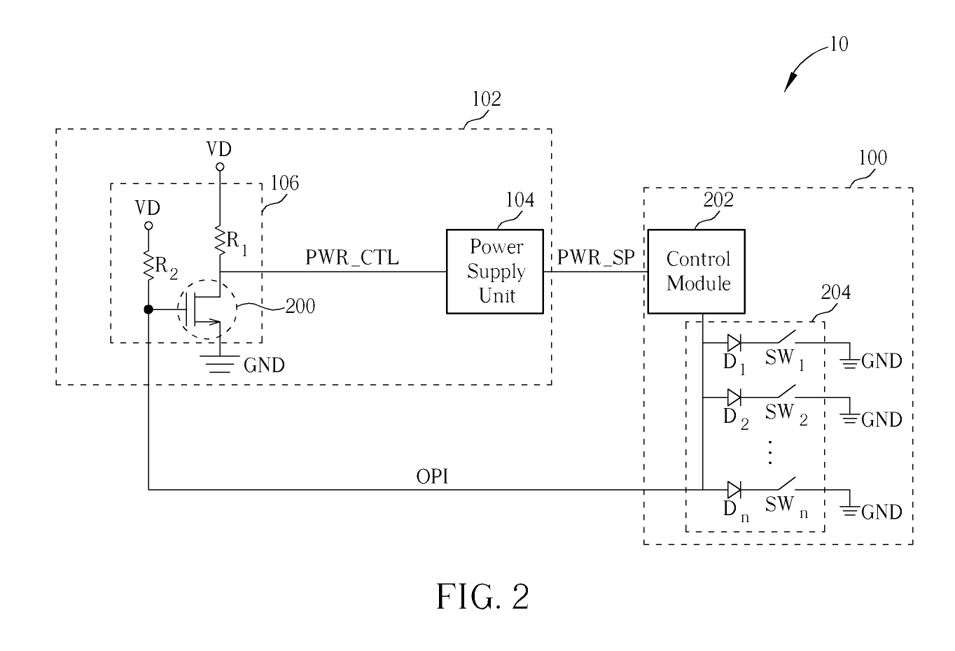

The electronic device 10 shown in FIG. 1 is an embodiment of the present invention and utilizes a block diagram to explain one concept of the present invention. Therefore, the methods of each block and the generation methods of the related signals can be modified according to various system demands. For example, please refer to FIG. 2, where FIG. 2 is a schematic diagram of another implementation of the electronic device 10. As shown in FIG. 2, the control circuit 106 comprises a transistor 200, a resistor R1 and a resistor R2. The transistor 200 is an N-type MOS, and controls a connection between the power control signal PWR_CTL and a ground GND according to the operating status indication signal OPI, so as to control power supplying status of the power supply unit 104. In addition, the embedded controller 100 comprises a control module 202 and a switch module 204. The control module 202 detects and determines the operating status of the embedded controller 10, so as to output the corresponding operating status indication signal OPI for controlling the power supplying status of the power supply unit 104. The switch module 104 comprise diodes D1-Dn and switches SW1-SWn, for detecting special events (such as whether a power button is pressed or whether an external power supplies the electronic device 10) and for outputting the appropriate operating status indication signal OPI to control the power supplying status of the power supply unit 104. For example, the switch SW1 is controlled by the power button, i.e. the switch SW1 conducts the connection between corresponding diode D1 and the ground GND when the power button is pressed. On the other hands, the switch SW2 conducts the connection between the corresponding diode D2 and the ground GND when an external power source is applied to the electronic device 10. Accordingly, the switch module 204 adjusts voltage level of the operating status indication signal OPI through controlling the switches SW1-SWn, so as to control the power supplying status of the power supply unit 104.

In detail, when the electronic device 10 is in a turn-off status, the control module 202 outputs the operating status indication signal OPI in high logic level, i.e. the connection between the power control signal PWR_CTL and the ground GND is conducted. In such a condition, the voltage level of the power control signal PWR_CTL is pulled down to the voltage level of the ground GND, i.e. a low logic level, so as to control the power supply unit 104 to stop outputting the power PWR_SP. When the power button is pressed, the switch SW1 is conducted then the diode D1 is conducted, thus, the operating status indication signal OPI is pulled down to low logic level. Therefore, the transistor 200 operates in cut-off region and the voltage of the power control signal PWR_CTL is pulled up to voltage of a power source VD, i.e. high logic voltage, so as to control the power supply unit 104 to start outputting the power PWR_SP. In other words, the power supply unit 104 starts outputting the power PWR_SP according to the power control signal PWR_CTL with high logic voltage. Similarly, when external power is applied to the to electronic device 10, the switch SW2 is conducted, then the operating status indication signal OPI is pulled down to low logic voltage, so as to control the power supply unit 104 to start outputting the power PWR_SP.

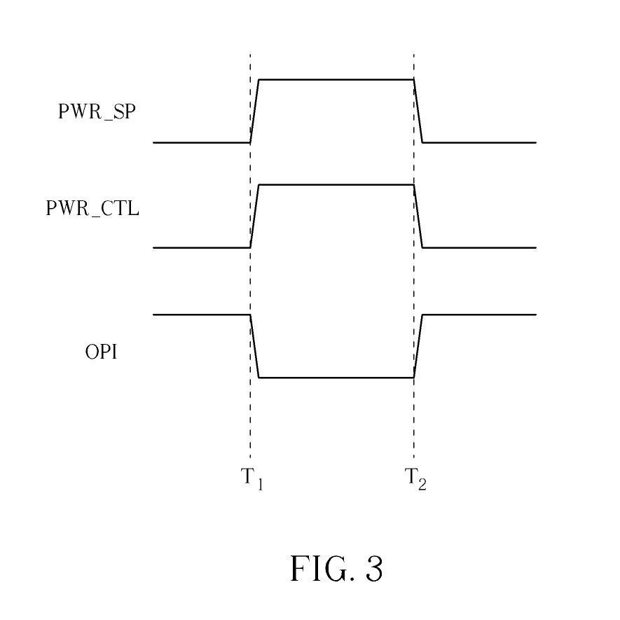

Furthermore, please refer to FIG. 3, which is a waveform chart of related operation signals of the electronic device 10 shown in FIG. 2. As shown in FIG. 2, the electronic device 10 is in the turn-off status before a time T1. Therefore, the voltage of operating status indication signal OPI is high logic voltage and the voltage of power control signal PWR_CTL is low logic voltage. In such a condition, the power supply unit 104 does not output the power PWR_SP. When the power button is pressed or the external power supplies the electronic device 10 at the time T1, the voltage of operating status indication signal OPI is pulled down to the low logic voltage and the voltage of power control signal is pulled up to the high logic voltage, then the power supply unit 104 starts outputting the power PWR_SP. The electronic device 10 enters the turn-off status at a time T2, the voltage of the operating status indication signal OPI is pulled up to the high logic voltage and the voltage of the power control signal is pulled down to the low logic voltage, then the power supply unit 104 stops outputting the power PWR_SP.

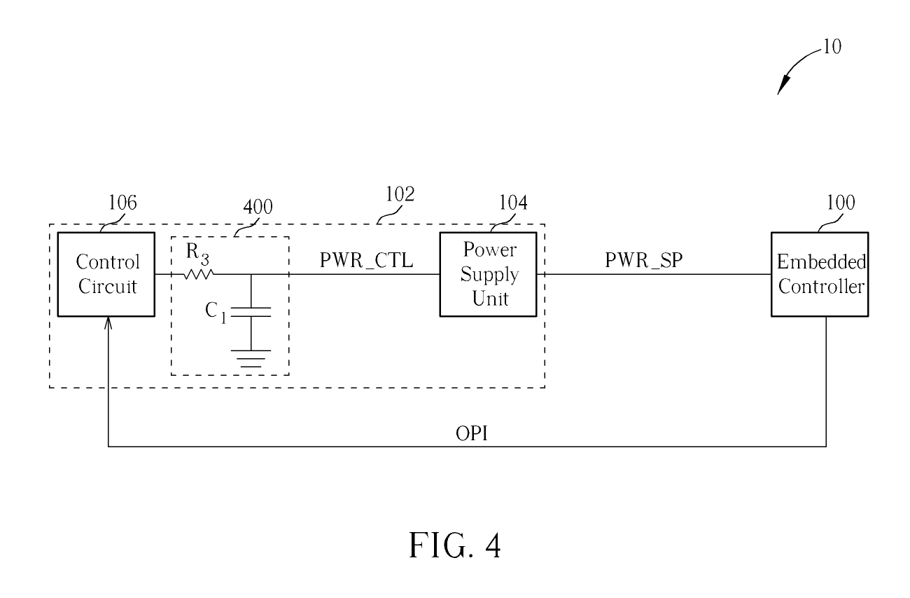

Noticeably, the main spirit of the present invention is controlling the power supply unit to stop outputting the power to the embedded controller when the electronic device is in the turn-off status, so as to decrease the power consumption of the electronic device. Various modifications can be accordingly made and all the modifications belong to the present invention. For example, the transistor 200 also can be an NPN-type BJT. Besides, a low-pass filter or a buffer can be added between the control circuit 106 and the power supply unit 104, to degrade noise of the power control signal PWR_CTL. Please refer to FIG. 4, the power control device 102 may also comprise a buffer 400 for filtering noise. As shown in FIG. 4, the buffer 400 may comprise a resistor R3 and a capacitor C1 and be utilized for degrading noise of the power control signal PWR_CTL, so as to stabilize the operation of the electronic device 10.

To sum up, in the prior art, the electronic device needs to offer power to the embedded controller when the electronic device is in a turn-off status, to ensure the electronic device can be rebooted properly. In comparison, via the operation of the power control device of the present invention, the electronic device stops offering power to the embedded controller when the electronic device operates in the turn-off status, so as to effectively decrease the power consumption of the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power control device, for an electronic device, comprising:
a power supply unit, for outputting a power to an embedded controller of the electronic device according to a power control signal; and
a control circuit, coupled to the power supply unit and the embedded controller for outputting the power control signal according to an operating status indication signal, so as to control the power supply unit to stop outputting the power to the embedded controller when the operating status indication signal signifies a turn-off status.

2. The power control device of claim 1, wherein the control circuit is a transistor comprising:
a first node coupled to the embedded controller and a power source;
a second node coupled to the power source and the power supply unit; and
a third node coupled to a ground;
wherein the transistor is configured for controlling a link between the second node and the third node according to the operating status indication signal, so as to generate the power control signal at the second node.

3. The power control device of claim 2, wherein the transistor is an N-type MOS, the first node is a gate, the second node is a drain and the third node is a source.

4. The power control device of claim 2, wherein the transistor is an NPN-type BJT, the first node is a base, the second node is a collector and the third node is an emitter.

5. The power control device of claim 1, further comprising a buffer coupled between the control circuit and the power supply unit.

6. The power control device of claim 1, wherein the control circuit is further configured for controlling the power supply unit to output the power to the embedded controller via the power control signal when the operating status indication signal outputted by the embedded controller signifies an operating status.

7. The power control device of claim 6, wherein the embedded controller outputs the operating status indication signal signifying the operating status when a power button of the electronic device is enabled.

8. The power control device of claim 7, wherein the control circuit is further coupled to the power button, for controlling the power supply unit to output the power to the embedded controller via the power control signal when the power button is enabled.

9. The power control device of claim 6, wherein the embedded controller outputs the operating status indication signal signifying the operating status when an external power supplies the electronic device.

10. The power control device of claim 9, wherein the control circuit is further coupled to the external power, for controlling the power supply unit to output the power to the embedded controller via the power control signal when the external power supplies the electronic device.

11. An electronic device, comprising:
an embedded controller;
a power control device, comprising:
a power supply unit, for outputting a power to the embedded controller according to a power control signal; and
a control circuit, coupled to the power supply unit and the embedded controller for outputting the power control signal according to an operating status indication signal, so as to control the power supply unit to stop outputting the power to the embedded controller when the operating status indication signal signifies a turn-off status.

12. The electronic device of claim 11, wherein the control circuit is a transistor comprising:
a first node coupled to the embedded controller and a power source;
a second node coupled to the power source and the power supply unit; and
a third node coupled to a ground;
wherein the transistor is configured for controlling a link between the second node and the third node according to the operating status indication signal, so as to generate the power control signal at the second node.

13. The electronic device of claim 12, wherein the transistor is an N-type MOS, the first node is a gate, the second node is a drain and the third node is a source.

14. The electronic device of claim 12, wherein the transistor is an NPN-type BJT, the first node is a base, the second node is a collector and the third node is an emitter.

15. The electronic device of claim 11, further comprising a buffer coupled between the control circuit and the power supply unit.

16. The electronic device of claim 11, wherein the control circuit is further configured for controlling the power supply unit to output the power to the embedded controller via the power control signal when the operating status indication signal outputted by the embedded controller signifies an operating status.

17. The electronic device of claim 16, wherein the embedded controller outputs the operating status indication signal signifying the operating status when a power button of the electronic device is enabled.

18. The electronic device of claim 17, wherein the control circuit is further coupled to the power button, for controlling the power supply unit to output the power to the embedded controller via the power control signal when the power button is enabled.

19. The electronic device of claim 16, wherein the embedded controller outputs the operating status indication signal signifying the operating status when an external power supplies the electronic device.

20. The electronic device of claim 19, wherein the control circuit is further coupled to the external power, for controlling the power supply unit to output the power to the embedded controller via the power control signal when the external power supplies the electronic device.
